(19) United States
(12) Patent Application Publication
(10) Pub. No.: US 2002/0055760 A1
(43) Pub. Date: May 9, 2002

(54) PACIFIER

(76) Inventor: AVRAHAM AVITAL, ZION (IL)

Correspondence Address: SUGHRUE MION ZINN MACPEAK & SEAS, 2100 PENNSYLVANIA AVENUE NW, WASHINGTON, DC, 20037-3213, US

(21) Appl. No.: 09/486,931

(22) PCT Filed: Sep. 3, 1998
(86) PCT No.: PCT/IL98/00428

(30) Foreign Application Priority Data
Sep. 3, 1997 (IL) 121696

(51) Int. Cl. A61J 17/00

(52) U.S. Cl. 606/234

(57) ABSTRACT

The invention provides a pacifier, including a nipple consisting of a nipple head and a nipple neck, a shield fixedly attached to, or integral with, the nipple neck, wherein the nipple bead is provided with at least one first opening adapted to communicate with the free atmosphere to enable its user to bypass any obstruction in the nasal airways and maintain an open channel to the ambient air.

### TECHNICAL FIELD

The present invention relates to a breathe-through pacifier.

### BACKGROUND ART

Newborns and young children use pacifiers mainly during sleep, starting from the first months of life until the age of 2-3 years. Newborns are obligatory nose-breathers until the age of 4-6 months, and any problem causing nasal congestion or obstruction, such as an upper respiratory tract infection, may induce sleep disturbances and even obstructive sleep apnea.

Nasal congestion or obstruction in children may have various causes, for instance, adenoid hypertrophy (enlarged lymph gland at the inner part of the nasal passages), choanal stenosis (constriction of nasal passages), or even the common cold. Whatever is the cause, nasal congestion plays a major role in the pathogenesis of pulmonary, cardiac and even neurological complications, and may be one of the major causes of Sudden Infant Death Syndrome (SIDS).

### DISCLOSURE OF THE INVENTION

It is thus one of the objects of the present invention to provide a device that will enable its user to bypass any obstruction in the nasal airways and maintain an open channel to the ambient air.

According to the invention, the above object is achieved by providing a pacifier, comprising a nipple consisting of a nipple head and a nipple neck, a shield fixedly attached to or integral with said nipple neck, wherein said nipple head is provided with at least one first opening adapted to communicate with the free atmosphere.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of a first embodiment of the pacifier according to the present invention;

FIG. 2 is a lateral view of the embodiment of FIG. 1;

FIG. 3 is a perspective view of another embodiment of the pacifier;

FIG. 4 is a lateral view of the embodiment of FIG. 3;

FIG. 5 is a cross-sectional view of the nipple head section of an embodiment provided with a longitudinal groove leading into the free atmosphere;

FIG. 6 is a view similar to FIG. 5, showing two lateral grooves, and

FIG. 7 illustrates a fully enclosed tubular duct.

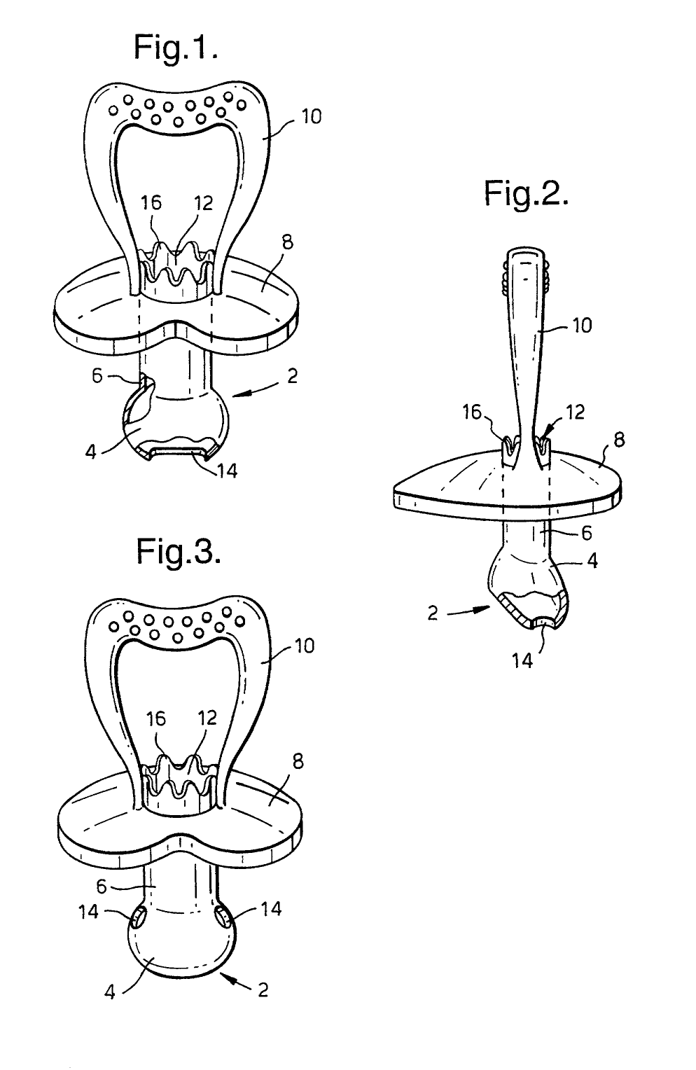

Referring now to the drawings, there is seen in FIGS. 1 and 2 a pacifier made of a tough but flexible plastic, comprising a nipple 2 consisting of a head section 4 and a neck section 6, a shield 8 fixedly attached to, or integral with, the neck portion 6 and a handle 10. Nipple 2 is hollow and the space defined by it opens into the free atmosphere beyond shield 8 via an opening 12 at the end of the neck section 6. Another opening 14 is seen at the end of the head section 4. Further seen is a serrated, crenellated or fenestrated rim 16 for preventing accidental obstruction of the channel constituted by nipple 2. The baby or infant sucking this pacifier is thus able to breathe through nipple 2, regardless of a possible blockage or congestion in the nasal tract.

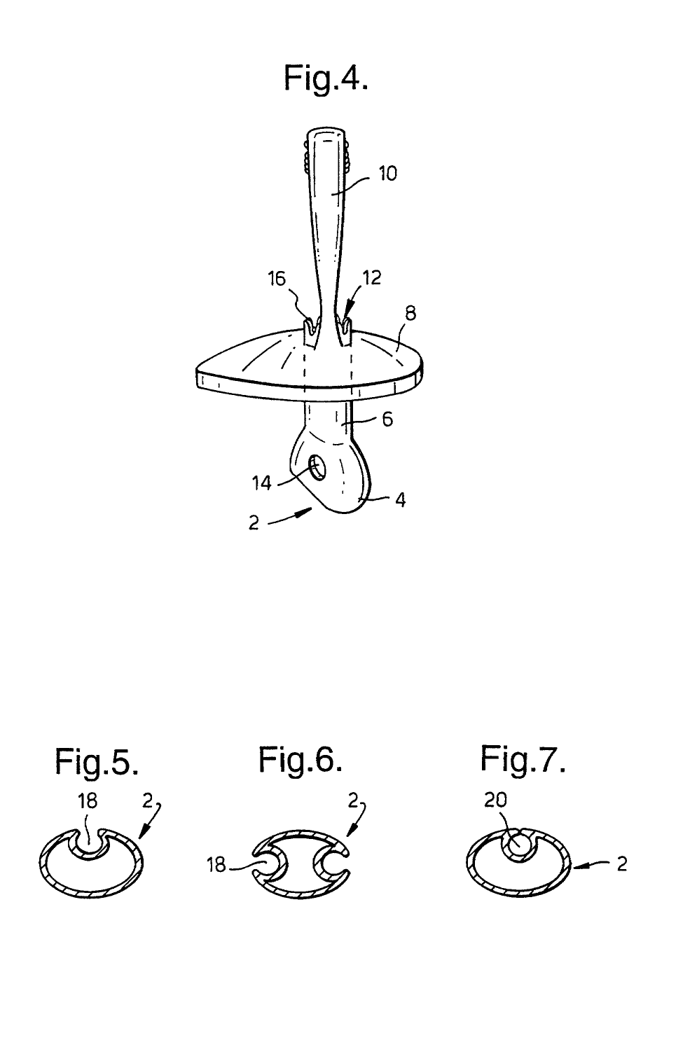

FIGS. 3 and 4 illustrate another embodiment of the pacifier according to the invention. As can be seen, the difference between the two embodiments resides in the fact that opening 14 is not located at the end of nipple head 4 (where it possibly might be occluded by the baby's tongue), but on each lateral portion of head 4, where openings 14 are well out of reach of the tongue.

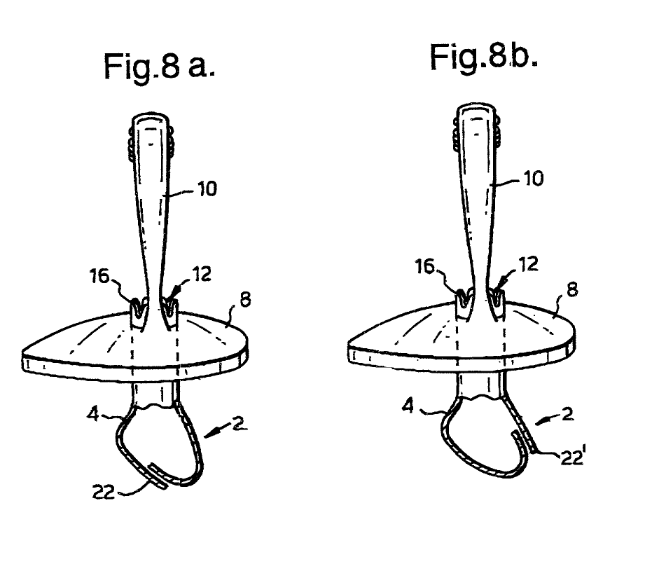

Some infants might not like the pacifier according to FIGS. 1-4, because of their inability to suck the nipple head efficiently. For such cases, it is possible to provide pacifiers in which openings 14 are replaced by groove 18, as seen in the cross-sectional view of FIG. 5, produced in nipple 2 by “invagination” which, starting somewhere on head section 4, leads beyond shield 8 into the free atmosphere. It is also possible to have two lateral grooves 18 as shown in FIG. 6, or even a fully enclosed tubular duct 20 (FIG. 7).

It is also possible to provide the nipple with a one-way valve sensitive enough to respond to a minimal respiratory effort, i.e., a minimal negative pressure, but not permitting exhaled air to enter nipple 2, thereby preventing the deposition therein of mucous substances. In this case, exhaled air will simply escape between the baby's lips and shield 8.

While these pacifiers are obviously intended for babies and toddlers, if made of an appropriate size they could also be of use to adults suffering from obstructive sleep apnea associated with snoring, hypoxia and hypercarbia.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A breathe-through, pacifier-like device, comprising:
a nipple consisting of a nipple head and a nipple neck,
a shield fixedly attached to, or integral with, said nipple neck,
characterised in that said nipple head is provided with at least one first opening adapted to communicate with the free atmosphere, to enable its user to bypass any obstruction in the nasal airways and maintain an open channel to the ambient air.

2. A breathe-through, pacifier-like device, comprising:
a nipple consisting of a nipple head and a nipple neck,
a shield fixedly attached to, or integral with, said nipple neck,
wherein said nipple head is provided with at least one first opening adapted to communicate with the free atmosphere;
characterized in that said first opening is selected from any one of the group of openings comprising an opening located on a lateral portion of said nipple head, an opening in the form of at least one groove, or an opening in the form of at least one tubular duct.

3. The device as claimed in claim 1 or claim 2, wherein said at least one first opening communicates with the free atmosphere via a second opening provided in said nipple neck.

4. The device as claimed in claim 1 or claim 2, further comprising a serrated or fenestrated rim surrounding said second opening in said nipple neck.
